(19) United States
(12) Patent Application Publication
(10) Pub. No.: US 2011/0029517 A1
(43) Pub. Date: Feb. 3, 2011

(54) GLOBAL AND TOPICAL RANKING OF SEARCH RESULTS USING USER CLICKS

(76) Inventors: Shihao Ji, Santa Clara, CA (US); Anlei Dong, Fremont, CA (US); Ciya Liao, Fremont, CA (US); Yi Chang, Santa Clara, CA (US); Zhaohui Zheng, Sunnyvale, CA (US); Olivier Chapelle, Sunnyvale, CA (US); Gordon Guo-Zheng Sun, Redwood City, CA (US); Hongyuan Zha, Atlanta, GA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/533,564

(22) Filed: Jul. 31, 2009

(51) Int. Cl. G06F 17/30

(52) U.S. Cl. 707/734; 707/E17.014; 706/45

(57) ABSTRACT

To estimate, or predict, the relevance of items, or documents, in a set of search results, relevance information is extracted from user click data, and relational information among the documents as manifested by an aggregation of user clicks is determined from the click data. A supervised approach uses judgment information, such as human judgment information, as part of the training data used to generate a relevance predictor model, which minimizes the inherent noisiness of the click data collected from a commercial search engine.

### FIELD OF THE DISCLOSURE

A system and method of ranking search results based on relevance information extracted from user click data, and in particular exploiting sequential, supervised learning in search result ranking.

### BACKGROUND

One determinant of the effectiveness of a search engine is the quality of the ranking function(s) used by the search engine. The ranking can be used to order items in the search results and/or whether or not to cull items from the set of search results, for example. A key contributor to effective ranking is a set of features or descriptors to represent a query-document pair that are accurate indicators of the degree of relevance of the document with respect to the query. Different data sources are explored in building the ranking functions. Conventional information retrieval systems relied heavily on exploring textual data. For example, feature-oriented probabilistic indexing methods use textual features such as the number of query terms, length of the document text, term frequencies for the terms in the query to represent a query-document pair; and vector space models use the raw term and document statistics to compute the similarity between a document and a query. Another conventional method uses the hyperlink structures of web documents, among them are those based on PageRanks and anchor texts, which substantially contributed to the popularity of the Google search engine.

Several machine learning based ranking methods have been proposed, including RankSVM, RankNet and GBrank. Although these ranking methods are quite different in terms of ranking models and optimization techniques, all of them can be regarded as “local ranking”, in the sense that the ranking model is defined on a single document. More particularly, in “local ranking” the ranking score of a current document is largely based on the feature vector for the document without considering the possible relationships that the document may have with other documents to be ranked. For many applications, the local ranking of a document is only a loose approximation, since relational information among documents typically exists, e.g., in some cases two similar documents are preferred having similar relevance scores, and in other cases a parent document should be potentially ranked higher than its child documents.

### SUMMARY

A ranking model uses both local, as defined on a single document, and global, and as defined on more than one document, information, and provides an improved ranking of the documents, or other search items, as a function of all the documents to be ranked. In accordance with one or more embodiments, the ranking model uses user click data, users' click decisions among different documents displayed in a search session, which tend to rely on the relevance judgment of a single document and on the relative relevance among the documents displayed; and user click sequences as an indicator of the relevance of the documents with regard to the query.

In accordance with one or more embodiments, relevance information is extracted from user click data via global ranking. A global ranking framework of modeling user click sequences using one or more sequential supervised methods, such as, without limitation, conditional random field (CRF), sliding window and recurrent sliding window methods, or frameworks, is described. In accordance with one or more embodiments, the sliding and/or recurrent slicking window method can be implemented using the GBrank training method.

In accordance with one or more embodiments, a method is provided, the method comprising training a relevance prediction model using data for a plurality of queries, the data for a query comprising information identifying the query and documents of a result set retrieved using the query, the data further comprising user click information identifying each user click and corresponding document in the result set and a time of the user click, the training comprising determining a plurality of feature vector sets corresponding to the plurality of queries, a feature vector set for a query comprising a feature vector for each document in the result set of the query, the feature vector identifying a plurality of features and a corresponding plurality of feature values, the plurality of features for a document comprising at least one feature that relates the document to at least one other document in the result set of the query using the user click information to determine whether or not a user click sequence involving the document and the at least one other document exists, determining a plurality of label sets corresponding to the plurality of queries, a label set for a query comprising a label for each document in the result set of the query, the label comprising an assessment of the document's relevance to the query, and generating the relevance prediction model using the feature vector and label sets. Ranking predictions are obtained for the documents in a result set of a query using the relevance prediction model.

In accordance with one or more embodiments, a system comprising at least one server is provided, the at least one server comprising a training data generator, a relevance predictor model generator, and a relevance predictor. The training data generator uses data for a plurality of queries to determine a plurality of feature vector sets and a plurality of label sets corresponding to the plurality of queries, the data for a query comprising information identifying the query and documents of a result set retrieved using the query, the data further comprising user click information identifying each user click and corresponding document in the result set and a time of the user click, a feature vector set for a query comprising a feature vector for each document in the result set of the query, the feature vector identifying a plurality of features and a corresponding plurality of feature values, the plurality of features for a document comprising at least one feature that relates the document to at least one other document in the result set of the query using the user click information to determine whether or not a user click sequence involving the document and the at least one other document exists, and a label set for a query comprising a label for each document in the result set of the query, the label comprising an assessment of the document's relevance to the query. The a relevance predictor model generator generates a relevance prediction model using the plurality of feature vector and label sets, and the relevance predictor obtains, using the generated relevance prediction model, ranking predictions for documents in a result set of a query.

In accordance with one or more embodiments, a computer-readable medium is provided, which medium tangibly stores thereon computer-executable process steps. The process steps comprise training a relevance prediction model using data for a plurality of queries, and obtaining ranking predictions for documents in a result set of a query using the generated relevance prediction model. The data for a query comprising information identifying the query and documents of a result set retrieved using the query, the data further comprising user click information identifying each user click and corresponding document in the result set and a time of the user click. Training a relevance prediction model using the data for a plurality of queries comprises determining a plurality of feature vector sets corresponding to the plurality of queries, a feature vector set for a query comprising a feature vector for each document in the result set of the query, the feature vector identifying a plurality of features and a corresponding plurality of feature values, the plurality of features for a document comprising at least one feature that relates the document to at least one other document in the result set of the query using the user click information to determine whether or not a user click sequence involving the document and the at least one other document exists, determining a plurality of label sets corresponding to the plurality of queries, a label set for a query comprising a label for each document in the result set of the query, the label comprising an assessment of the document's relevance to the query, and generating the relevance prediction model using the feature vector and label sets.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides an exemplary component overview in accordance with one or more embodiments of the present disclosure.

FIG. 2 provides examples of features used in accordance with one or more embodiments of the present disclosure.

FIG. 3 provides an example of query sessions in accordance with one or more embodiments of the present disclosure.

FIG. 4 provides a process overview in accordance with one or more embodiments of the present disclosure.

FIG. 5 provides a model generation process flow used in accordance with one or more embodiments of the present disclosure.

FIG. 6 provides a relevance prediction process flow used in accordance with one or more embodiments of the present disclosure.

FIG. 7 provides examples of metrics used in pair-wise judgment extraction in accordance with one or more embodiments of the present disclosure.

FIG. 8 illustrates some components that can be used in connection with one or more embodiments of the present disclosure.

FIG. 9 provides an example of a block diagram illustrating an internal architecture of a computing device in accordance with one or more embodiments of the present disclosure.

### DETAILED DESCRIPTION

In general, the present disclosure includes a global and topical ranking using user click data system, method and architecture.

Certain embodiments of the present disclosure will now be discussed with reference to the aforementioned figures, wherein like reference numerals refer to like components.

In accordance with one or more embodiments disclosed herein, relevance information is extracted from user click data via a global ranking framework; relational information among the documents as manifested by an aggregation of user clicks is used. Experiments on the click data collected from a commercial search engine demonstrate the effectiveness of this approach, and its superior performance over a set of widely used unsupervised methods, such as the cascade model and the heuristic rule based methods. Since user click data is inherently noisy, a supervised approach, which uses human judgment information as part of the training data used to generate a relevance predictor model, provides a degree of reliability over an unsupervised approach. Advantageously, by exploring supervised learning in click data modeling, a click model such as that disclosed in accordance with one or more embodiments can reliably extract relevance information by calibrating with human relevance judgments.

In accordance with one or more embodiments, user sequential click information is exploited, as a reliable relevance indicator for the documents displayed in a search result, and a global ranking function is trained using click information within a supervised learning framework, which uses judgments, such as human judgments, together with the click information, to train the global ranking function.

In accordance with one or more embodiments, click data from a plurality of query sessions is used to train one or more relevance predictor models, and a trained relevance predictor model is used to rank items in a search query according to relevance. In accordance with one or more embodiments, global feature vectors extracted from the training data, which takes into account click data sequences between items in a query session, is used. In accordance with one or more embodiments, a feature vector includes values extracted from training data, and the training data comprises click data corresponding to search result items.

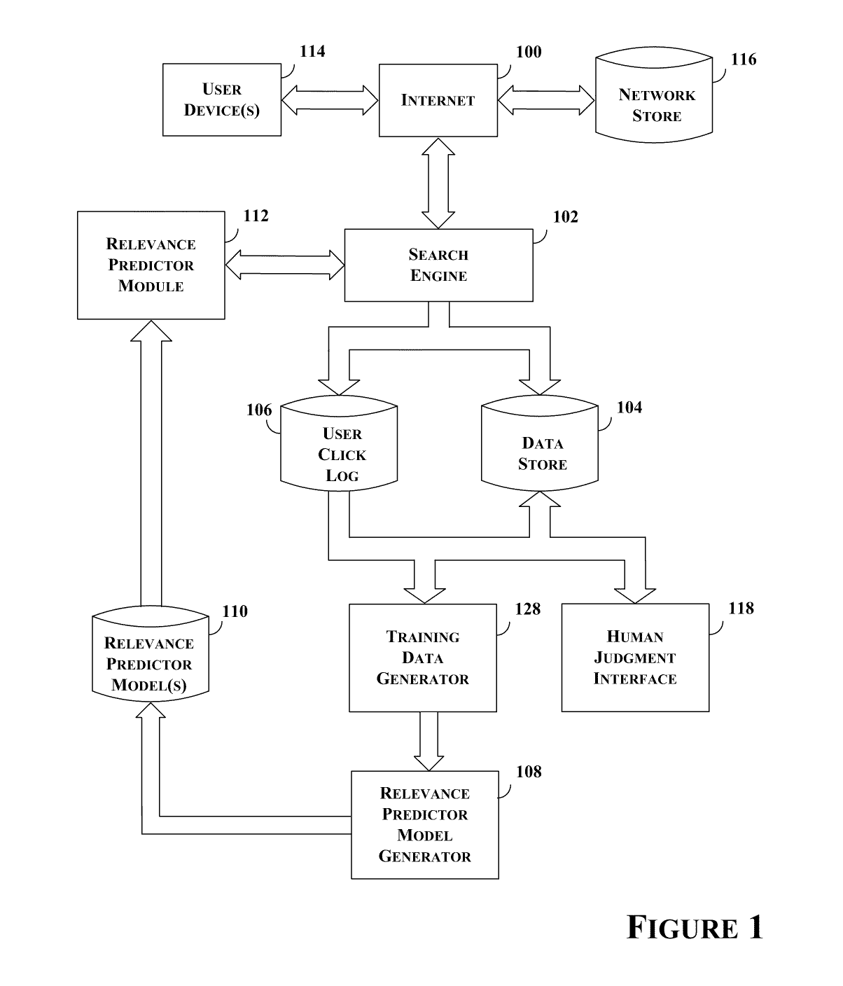

FIG. 1 provides a component overview in accordance with one or more embodiments of the present disclosure. In the example shown in FIG. 1, a search engine 102 comprises one or more of a crawler, searcher and ranker, one or more of which uses a relevance predictor module 112 to optimize its operation. By way of a non-limiting example, the crawler can use the relevance predictor module 112 in determining whether or not to retrieve a resource, the searcher can use the relevance predictor module 112 to determine what items are to be included in a set items that comprise a search result to be returned to a user in response to a search request received from a user device 114, and the ranker can use the relevance predictor 112 to determine an ordering, or ranking, of the items in a set of items, e.g., items in a search result.

Internet 100 is used by search engine 102 to crawl network stores 116 and as a mechanism to communicate with user device(s) 114, for example. It should be apparent that Internet 100 can be any network, including without limitation one or more of the World Wide Web, wide area network, local area network, etc.

As is discussed in more detail below, user click log 106 comprises information identifying a plurality of query, or click, sessions, each session containing information identifying the query submitted to search engine 102, the documents included in the search result set, and the click information indicating whether a document is clicked or not, and a time stamp of each click identifying the timing of each click. In accordance with one or more embodiments, training data generator 128 generates training data using data from user click log 106, such as and without limitation user click data, and human judge input received via human judge interface 118. Training data generator 128 can comprise a training data aggregator, which aggregates data from multiple sessions for a given query in accordance with one or more embodiments. In accordance with one or more embodiments, training data generator 128 can comprise a vector generator, which extracts features from the training data and generates a feature vector corresponding to a document in a search result set. In accordance with one or more embodiments, the vector generator generates a label vector identifying a relevance measure for each document in the search result set, which relevance measure is identified using human judgment input. In accordance with one or more embodiments, training data generator comprises a topical training data generator for generating training data for a given topic, or query, category.

Model generator 108 generates one or more relevance predictor models 110 using training data generated by training data generator 128. In accordance with one or more embodiments, model generator 108 uses a model generation method, such as and without limitation conditional random fields (CRF), sliding, or recurrent sliding, window method. In accordance with one or more embodiments, the sliding and/or recurrent slicking window method can be implemented using the GBrank training method. In accordance with one or more such embodiments, model generator 108 provides training data, which comprises local and global feature data corresponding to the training data, to the model generation method to generate a relevance predictor model 110. Local and global feature vectors corresponding to a set of search result items to be ranked can then be provided, by search engine 102, for example, to the relevance predictor model 110 to obtain ranking information, which is used to rank the items in the search result. In accordance with one or more embodiments, a feature vector includes values extracted from click data corresponding to the set of search result items.

A set of search results, x^{(q)}, for a query, q, that retrieves a number, n, documents, x₁, x₂, . . . , xₙ, can be expressed as follows:

x^{(q)}={x₁^{(q)},x₂^{(q)},K,xₙ^{q}} Exp. (1)

In accordance with one or more embodiments, a training data set includes a plurality of queries, a plurality of feature vectors associated with each query and a label associated with each feature vector. By way of a non-limiting example, each query has a set of search results containing at least one item, or document. As is discussed below, all or a portion, e.g., the first ten, of the documents in a search result set can be considered, and each item considered has an associated feature vector and a label. Each label used in the training data set is provided by a human judge; each label comprises information of a human judge's assessment of the relevance assessment of an item, or document, to a query. Each feature vector comprises a plurality of features and a value for each of the plurality of features. In accordance with one or more embodiments, the feature vector comprises both global and local features. In accordance with one or more embodiments, features for a query session comprise features extracted using click data for the query session. In accordance with one or more alternate embodiments, the feature vector comprises global features. In accordance with one or more embodiments, various types of click features can be used in the model and aggregated click features can be extracted from user click, or query, sessions.

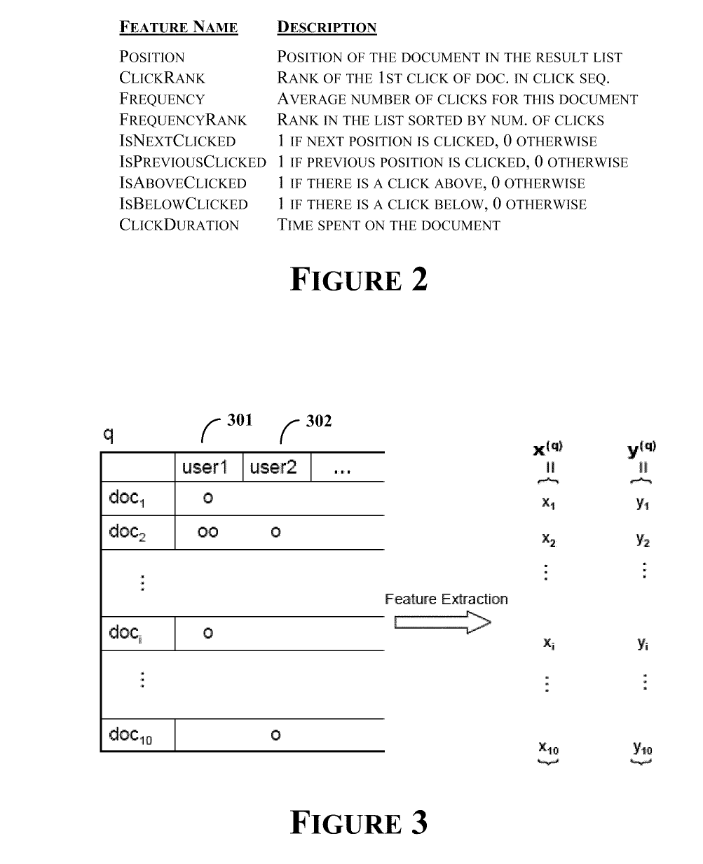

Examples of features used in a model in accordance with one or more embodiments are listed in a table shown in FIG. 2. The features shown in FIG. 2 comprise click-related features extracted from user click data. Features, such as those shown in FIG. 2, can be used to form a feature vector, which identifies a correspondence between a feature and a value for the feature. A value is assigned for each feature in a feature vector based on information extracted from the user click log 106. In accordance with one or more embodiments, the feature set comprises local features, each of which has a value determined based on information extracted for a single document, and global features, each of which has a value determined based on relationships between two or more documents. The Frequency feature, which identifies the number of clicks for a given document is one non-limiting example of a local feature. The FrequencyRank feature, which identifies the rank of the document in a list of the documents sorted by the number of clicks associated with each of the documents, is one non-limiting example of a global feature. Some of the features in the table shown in FIG. 2 are independent of temporal information of the clicks, such as and without limitation Position, Frequency and FrequencyRank, features, such as IsNextClicked, IsPreviousClicked, IsAboveClicked, and IsBelowClicked, rely on their surrounding documents and the click sequences, and features, such as and without limitation ClickRank and ClickDuration, have a temporal aspect.

In accordance with one or more embodiments, a feature's value is based on a single query session, e.g., one user's interaction with a search result set returned for a given query. In such a case and by way of a non-limiting example, the Position feature identifies the position, or rank, of the document in the search result set, e.g., a location as the first, second, third, etc. for display by the user's device 114. A query can be associated with multiple sessions, e.g., more than one user enters the same query, the same user enters the same query multiple times, etc. Each session has associated click data, which can be used to determine feature values. In accordance with one or more embodiments, multiple sessions for the same query are aggregated to determine the query's feature vector values. By way of a non-limiting example, the aggregate is determined to be the average of the feature values determined for each query session used to generate the aggregate. By way of a non-limiting example, an aggregate value of the Position feature identifies the average position of the document in the multiple sessions considered for the same query. In accordance with one or more embodiments, feature data is extracted from training data aggregated for a query, i.e., an aggregated query session. In accordance with one or more such embodiments, the aggregated query session data can be expressed as, for example:

<q, 10-document list, an aggregation of user clicks> Exp. (2)

With reference to Exp. (1) above, where aggregate session data is used in accordance with at least one embodiment, Exp. (1) denotes a sequence of feature vectors extracted from the aggregated sessions, with xᵢ^{(q)} representing the feature vector extracted for the document i. More particularly, in accordance with one or more embodiments, to form vector xᵢ^{(q)}, a feature vector x_{i,j}^{(q)} is extracted from click data for each user, j, where jε{1, 2, K}, xᵢ^{(q)} is formed by averaging over {x_{i,j}^{(q)}, ∀jε{1, 2, K}},i.e., xᵢ^{(q)} is an aggregated feature vector for document i.

FIG. 3 provides one illustrative example of multiple sessions for a query, q. A feature extraction is shown for an aggregated session, with x^{{q}} denoting an extracted sequence of feature vectors, and y^{{q}} denoting the corresponding label sequence that is assigned by human judges for training.

In the example shown in FIG. 3, two sessions are shown with the top ten documents, e.g., the top ten ranked documents (doc₁, doc₂, . . . , docᵢ, . . . , doc₁₀, where i is a value between two and ten), from the two sessions. In the example shown, the two sessions both contain the same top ten documents; each row corresponds to a document, each column corresponds to a session, and each cell, i.e., intersection of row and column, identifies at least a portion of the click data for a document and query session. By way of a non-limiting example, the click data associated with session 301 indicates that the user clicked on documents doc₁ and docᵢ once and document doc₂ twice, indicates that a document above and below document doc₂ was clicked by the user, and further indicates that the document in the next position is clicked for doc₁ and that the document in the previous position is clicked for doc₂. In session 302, documents doc₂ and doc₁₀ were clicked on, and further indicates that a clicked occurred above doc₁₀ and below doc₂. By way of some further non-limiting examples, the time stamp information associated with each click can be used to identify a sequence of the document clicks, the first document clicked, e.g., for use in determining a value for ClickRank, and the time spent on a document, e.g., for use in determining a value for ClickDuration.

Session data such as that shown in FIG. 3 is examined and feature information is exacted to generate a feature vector, x, and a label vector, y, for each document for a given query, q. In the training data, the label vector, y, corresponds to a document and comprises a relevance value assigned by one or more human judges, e.g., a single relevance value assigned by one human judge or an aggregate of relevance values assigned by multiple judges, which value identifies the relevance of the document to the query. In accordance with one or more embodiments, an interface 118 is used to provide a query and a corresponding set of search results to one or more human judges, and to receive a relevance value for a document in a set of search results, the relevance value identifies the human judge's assessment of the relevance of the document to the query. As is discussed in more detail below, a human judge may be asked to select from a set of values, such as and without limitation the values identified in Exp. (4) below.

For purposes of training the model, in accordance with one or more embodiments, each query-document pair is assigned a label by human judges with y′ᵢ^{(q)}=f(xᵢ^{(q)}), ∀=1, K, n, in Exp. (3) below representing the sequence of assigned relevance labels. One or more human judges can be used to identify a relevance label for each of the documents, x. The relevance labels assigned by human judge(s) for the documents retrieved in query, q, as identified in Exp. (1), can be expressed as follows:

y^{(q)}={y₁^{(q)},y₂^{(q)},K,yₙ^{(q)}}, Exp. (3)

where y₁ represents a human judge's relevance label for document x₁, y₂ represents a human judge's relevance label for document x₂, etc. In accordance with one or more embodiments, each query-document pair is assigned a relevance label from an ordinal set. By way of a non-limiting example, a set of relevance labels can be as follows:

{Perfect, Excellent, Good, Fair, Bad}, Exp. (4)

each of which indicate a degree to which a document is relevant to a query, with Perfect being used to indicate a greatest degree of relevance and Bad being used to indicate the least degree of relevance, for example. In accordance with one or more embodiments, the relevance labels can be given a numeric value, such as without limitation, from 0 to 4, with Bad having a value of 0 and Perfect having a value of 4.

Each feature vector in the training set corresponds to a document in a set of search results for a query, and comprises a value for each feature in a set of features. By way of a non-limiting example, a feature vector, x_{doc}_{₁}^{(q)}, for document doc₁ relative to query, q, comprises values for features, and can be expressed as follows:

x_{doc}_{₁}^{(q)}=v₁^{(q,doc}^{₁}⁾,v₂^{(q,doc}^{₁}⁾,K,vₙ^{(q,doc}^{₁}⁾, Exp. (5)

where n is the number of feature vectors. By way of an example, if the feature vector contains values for the features shown in FIG. 2, n would be equal to 9, and v₁^{(q,doc}^{₁}⁾ represents the value of the Position feature value, v₂^{(q,doc}^{₁}⁾ represents the value of the ClickRank feature value, and so on, determined for document doc₁ relative to query q. As discussed herein, each value in the feature vector can be determined for a document based on a single session or based on multiple sessions, e.g., an average of the values of each of the multiple sessions.

Data store 104 stores resources retrieved by the crawler component of search engine 102. In addition, data store 104 can store one or more sets of training data. One or more of the relevance predictor models 110 generated by the model generator 108 are used by relevance predictor 112 to generate a relevance prediction for a document and query pair. A relevance prediction generated by relevance predictor 112 can be used by search engine 102 in one or more of its functions, e.g., crawling, searching, and ranking In accordance with one or more embodiments, data store stores human judgment data.

Local and Global Ranking

A local ranking model defines relevance for a single document, and relevance prediction using a local ranking model, f, can be expressed, without limitation, as follows:

yᵢ^{(q)}=f(xᵢ^{(q)}),∀=1,K,n, Exp. (6)

where y₁ represents a predicted, or estimated, relevance label for a document, xᵢ in the set of documents x₁ to xₙ retrieved for query, q, the relevance label being determined using a local ranking model, f.

In contrast to a local ranking model, a global ranking model takes into account all of the documents x₁ to xₙ for a query, q, as its inputs and uses both local and global information for the documents. By way of a non-limiting example, relevance prediction using a global ranking model, F, can be expressed as follows, for example:

yᵢ^{(q)}=F(x^{(q)}), Exp. (7)

In accordance with one or more embodiments disclosed, a global relevance prediction model, which uses local and global information among the documents to produce a document rank, is provided. In accordance with one or more embodiments, the function, F, in Exp. (7) can be learned from the training data, as discussed herein, using a training method, such as and without limitation, a CRF, sliding window method or recurrent sliding window training method adapted to use global ranking.

A local model is defined on a single document, and is therefore incapable of modeling user interactions with the documents in search results. In contrast, a global model advantageously can take into account sequential click data for all the documents in a search result, or an aggregate search result, and can predict relevance labels of all the documents jointly. By way of a non-limiting example, sequential click patterns embedded in an aggregation of user clicks can provide substantial relevance information of the documents displayed in the search results. An average number of sessions for a query in which a document at a certain position is skipped (not clicked) from all the sessions for the query is referred to herein as a skip rate. Empirically, in considering the skip rates for three relevance grades—Perfect, Good and Bad—observation shows that the skip rates are substantially higher for documents at the bottom of the result set regardless of the relevance grades of the documents. Documents with a Perfect relevance label generate more clicks at the top positions, but documents with Bad relevance label also garner substantial clicks on par with documents having a Good relevance label. This demonstrates that users tend to click the top documents even though the relevance grades of the documents are low and the raw click frequencies alone will not be a reliable indicator of relevance. Advantageously, information identifying the sequential nature of user clicks can be used in accordance with one or more embodiments. By way of a non-limiting example, with regard to a query: pregnant man, data identifying the sequence of clicks in a query session can be examined in connection with positions of documents in the result set. Two documents, referred to based on their respective positions in the result set as the second and third documents, have relevance labels Good and Excellent, respectively. The click logs from query, or click, sessions, indicate that there are 521 sessions with at least one click on the second document and 340 sessions on the third one. Relying on click frequency, even after discounting the factor of click frequency difference caused by ranking positions at 2 and 3, it is possible that one can be misled to an incorrect conclusion that the second document is more relevant than the third one. However, from examination of the data, there are 266 sessions where the second document, the document labeled Good, is clicked before the third document labeled Excellent, while there are only 12 sessions in which a reversed click order is observed. This sequential click pattern explains the “relevance disorder, i.e., most of the time, the users who clicked the second document labeled Good were dissatisfied with the information they acquired, and proceeded to click the third one labeled Excellent; however, if the users clicked the third document labeled Excellent, they seldom needed to click the second one labeled Good, indicating the higher relevance of the third document relative to the second document. Similar scenarios and sequential click patterns can be observed using other aggregated sessions. The example illustrates that sequential click patterns embedded in an aggregation of user clicks can provide substantial relevance information of the documents displayed in the search results.

In accordance with one or more embodiments, global ranking comprises ranking-targeted sequential learning. In accordance with at least one embodiment, click modeling uses a sequence of aggregated click features (statistics), rather than using single user's click sequence, as an input to the global ranking For a given query, generally, different users, or even the same user at different times, may have different click sequences, and some are actually quite different from others; but over many user sessions, certain consistent patterns may emerge, and can form the basis for the click model used to infer the relevance labels of the documents.

Training Data

In accordance with one or more embodiments, data collected from a commercial search engine for a period of time is obtained and used to generate training data. The collected data comprises information identifying a plurality of query, or click, sessions, where each session contains information identifying the query submitted to the search engine, the documents displayed in the result set, and the click information indicating whether a document is clicked or not, and the click time stamps. In accordance with one or more embodiments, a subset of the documents, e.g., the top ten documents in each user click session, such as the documents displayed in the first page of the result set. In some cases, in response to query input, search engines may return the top ten documents in varying orders, or some new documents may appear in the top ten documents due to search infrastructure changes and/or ranking feature updating. In accordance with at least one of the embodiments, all of the user sessions in the collection involving the same query are aggregated, and the user sessions that have the most frequent top ten documents are selected for the collection. The aggregate data for a query can be expressed using Exp. (2) above. Advantageously, a unique aggregated session can be used for each query in the dataset.

In accordance with one or more embodiments, each query-document pairing is assigned a label from an ordinal set identified in Exp. (4) to indicate the degree of relevance of the document with respect to the query in question, and to calculate click statistics and analyze user click behaviors. In accordance with one or more embodiments, the label is assigned using human judge input.

In accordance with one or more embodiments, user click data is collected from a commercial search engine over a certain period of time; a number of queries, such as and without limitation, 9677 queries, and corresponding sessions, such as and without limitation 9677 aggregated sessions), from the user click logs 106 that are both frequently queried by the users and have click rates over 1.0, where the click rate is defined as follows:

$$click\_rate ( query ) = \frac{{\sum }_{i ∈ sessions ( query )} no . ofclicks ( i )}{no . ofsessions ( query )} , \qquad Exp . ( 8 )$$

where i is an index into the sessions of a query.

Such a selection of queries ensures that each aggregated session will have enough user clicks to accumulate statistically significant click features. Input from human judges to label the top ten documents of each of the 9677 queries is obtained, to label each document as perfect, excellent, good, fair, or bad according to the document's degree of relevance with respect to the query. The obtained dataset can then be used to examine the performance of the proposed click modeling methods.

Conditional Random Fields (CRF) Model

Conditional random fields (CRFs) is a probabilistic model that can be used for sequential labeling in accordance with at least one embodiment of the present disclosure. Compared to hidden Markov models (HMMs), which define a joint probability distribution p(x, y) over an observation sequence x and a label sequence y, the CRF model defines a conditional probability distribution p(y|x) directly, which is used to label a sequence of observations x by selecting the label sequence y that maximizes the conditional probability. Because the CRF model is conditional, dependencies among the observations x do not need to be explicitly represented, affording the use of rich, global features of the input. Therefore, no effort is wasted on modeling the observations, and one is free from having to make unwarranted independence assumptions as required by the HMMs.

A CRF is a conditional distribution p(y|x) with an associated graphical structure, defining the dependencies among the components yᵢ of y globally conditioned on the observations x. One structure that can be used for modeling sequences is a linear chain, and the corresponding conditional distribution is defined as follows:

$$p ( x \vert y ) α exp \{ {\sum }_{j , t} {λ}_{j} {f}_{j} ( {y}_{t} , {y}_{t - 1} , x ) + {\sum }_{k , t} {μ}_{k} {g}_{k} ( {y}_{t} , x ) \} \qquad Exp . ( 9 )$$

where fⱼ(yₜ,yₜ₋₁,x) is a transition feature function, gₖ(yₜ,x) is an observation feature function and

Λ={λ₁,λ₂,Λ,μ₁,μ₂,Λ} Exp. (10)

are the parameters to be estimated. In general, the feature functions in Exp. (9) are defined on the entire observation sequence x. To minimize computational issues and to avoid overfitting, it is possible to use a subset of x in each feature functions, and j and k in Exp. (9) iterate over arbitrary subsets of x, either in time dimension or in feature dimension.

Given independent and identically-distributed (i.i.d.) training data D={xⁱ,yⁱ}ᵢ₋₁^{N}, where N is a number of queries, a maximum likelihood estimate can be used to compute the parameters Λ from

$$l ( Λ ) = {\sum }_{i}^{N} log p ( {y}^{i} \vert {x}^{i} ) \qquad Exp . ( 11 )$$

which is a concave function and can be optimized efficiently by using a quasi-Newton method, such as BFGS. Once the parameters Λ are determined, given a new observation sequence x*, the most probable label sequence y* can be computed by using the Viterbi function.

The following approximation can be used to produce continuous ranking scores. Besides generating the most probable label sequence y*, the Viterbi function also yields the class probabilities for each label yᵢ in y, i.e., p(yᵢ=g|x*), ∀iε{1, 2, . . . , T} and g ε{0, 1, 2, 3, 4}, where g denotes a relevance grade, with g=4 corresponding to Perfect and g=0 to Bad, and so on. The expected relevance can be used to convert class probabilities into ranking scores:

$${\tilde{y}}_{i} = {\sum }_{g = 0}^{4} g \times p ( {y}_{i} = g \vert {x}^{*} ) \qquad Exp . ( 12 )$$

There is improved performance of the approximation provided by Exp. (12) over the Viterbi function. In addition, the expected relevance generated using Exp. (12) can be used to convert classification categories into soft ranking scores.

Note that the CRF discussed herein in connection with embodiments of the present disclosure approaches the ranking problem as a classification/regression problem, and optimizes the CRF parameters in a maximum likelihood estimate without considering score ranks.

(Recurrent) Sliding Window Model(s)

In accordance with one or more embodiments, a simplified sequential learning method, such as and without limitation, a sliding window method or a recurrent sliding window method, are adapted to global ranking. A sliding window method used in accordance with one or more embodiments converts the sequential supervised learning problem into an ordinary supervised learning problem. In accordance with one or more embodiments, in a ranking context, the scoring function ƒ maps a set of consecutive observations in a window of width w into a ranking score. In particular, let d=(w−1)/2 be the half-width of the window. The scoring function uses

[symbol]

ᵢ=(x_{i-d},x_{i-d+1},Λ,xᵢ,Λ,x_{i+d-1},x_{i+d}) Exp. (13)

as an extended feature to predict the ranking score [symbol] ᵢ=ƒ(\hat{x}ᵢ), ∀ε{1, 2, Λ, T}. The sliding window method provides an approximation of the CRF, which has as an advantage its simplicity, and advantageously allows classical ranking methods to be applied to the global ranking problem.

Similarly, in a recurrent sliding window method, the predicted scores of the old observations are combined with the extended feature to predict the score of the current observation. Particularly, when predicting the score for xᵢ, available predicted scores, e.g., [symbol] _{i-d}, Λ, [symbol] ᵢ₋₁ can be used in addition to the sliding window to form the extended feature when predicting [symbol] ᵢ, i.e., the extended feature for xᵢ becomes

[symbol]

ᵢ=( [symbol] _{i-d},Λ, [symbol] ᵢ₋₁,x_{i-d},x_{i-d+1},Λ,xᵢ,Λ,x_{i+d}) Exp. (14)

In contrast to the sliding window method, the recurrent sliding window method is able to capture predictive information not being captured by the simple sliding window method. By way of a non-limiting example, if xᵢ, is being clicked and xᵢ₋₁ is not, the recurrent sliding window method likely will predict the relevance, [symbol] ᵢ, of document xᵢ to be greater than the relevance [symbol] ᵢ₋₁ of document xᵢ₋₁.

GBrank Model

Generally, GBrank is a learning to rank method trained on preference data, which is generated using absolute and/or relative relevance judgments, or labels. In accordance with one or more embodiments, human judgments are also referred to herein as absolute relevance judgments, with each judgment corresponding to a query-document pair and indicating a degree of relevance of the document to the query; relevance judgments extracted from clickthrough data, such as and without limitation user clickthroughs of search results, or converted from the absolute relevance judgments, are referred to as relative relevance judgment. By way of a non-limiting example, a user's on a document in a set of search results can be considered an implicit preference over another document in the set. As is discussed in more detail below, further analysis can be done to determine preferences using the clickthrough data. Absolute and/or relative judgments can be used to generate the preference data. In accordance with one or more embodiments, preference data is in the form of pair-wise comparisons, i.e., one document is more relevant than another with respect to a query. By way of a non-limiting example, given a query q and two documents u and v, if u has a higher human relevance label than v, e.g., Perfect versus Good, the preference u φ v, where φ indicates that the element to the left of the symbol is preferred over the element to the right of the symbol, is included in the extracted preference set, and vice versa. The relevance assigned to the documents by human judges can be considered for all pairs of documents within a search session that have unequal relevance labels. By considering all the queries in the dataset, a set of preference data can be extracted, which can be denoted as:

S={ [symbol] uᵢ,vᵢ [symbol] |uᵢφvᵢ,i=1,2,Λ,M} Exp. (15)

The learning to ranking function is cast as computing a ranking function h, such that h matches a given set of preferences as close as possible, e.g., h(uᵢ)≧h(vᵢ), if uᵢφvᵢ, i=1, 2, Λ, M. A squared hinge loss function can be used as a smooth surrogate of the total number of contradicting pairs in given preference data with respect to the function h. It can be said that u φ v is a contradicting pair with respect to h if h(u)<h(v). The following objective function, a squared hinge loss, can be used, in accordance with one or more embodiments, to measure the risk, R, of a given ranking function h:

$$R ( h ) = \frac{1}{2} {\sum }_{i - 1}^{N} {( max \{ 0 , h ( {v}_{i} ) - h ( {u}_{i} ) + τ \} )}^{2} ,$$

and the following minimization can be solved for:

$${min}_{h ∈ H} R ( h ) ,$$

where H is a function class, chosen to be linear combinations of regression trees, in accordance with one or more embodiments. The minimization problem can be solved by using functional gradient descent. The following provides a GBrank method for use in learning ranking function h using gradient boosting in accordance with one or more embodiments.

Start with an initial guess of h, h₀, for k=1; 2; . . . , K, where K is a number of iterations:

1. Using hₖ₋₁ as the current approximation of h, S is separated into two disjoint sets, as follows:

S⁺={(uᵢ,vᵢ)εS|hₖ₋₁(uᵢ)≧hₖ₋₁(vᵢ)+τ},

where τ is a fixed constant value such as and without limitation 0<τ≧1

and

S⁻={(uᵢ,vᵢ)εS|hₖ₋₁(uᵢ)<hₖ₋₁(vᵢ)+τ}

2. Fit a regression function (decision tree) gₖ(x) on the following training data

(uᵢ,[hₖ₋₁(vᵢ)−hₖ₋₁(uᵢ)+τ]),

(vᵢ,[hₖ₋₁(vᵢ)−hₖ₋₁(uᵢ)+τ]),∀ [symbol] uᵢ,vᵢ [symbol] εS⁻

3. Form the new ranking function as hₖ(x)=hₖ₋₁(x)+ηgₖ(x), where η is a shrinkage factor.

In accordance with one or more embodiments, the shrinkage factor, η, and the number of iterations K, can be determined using cross-validation.

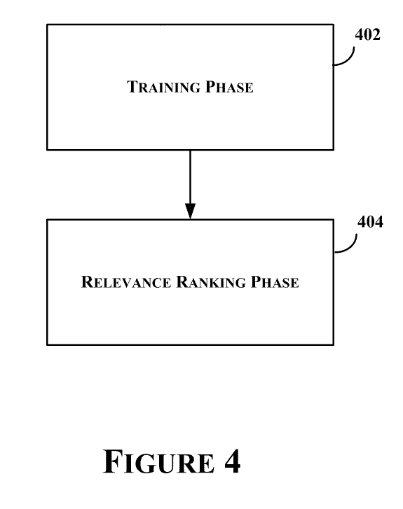

FIG. 4 provides a process overview in accordance with one or more embodiments of the present disclosure. In accordance with one or more embodiments, one or more relevance predictor models 110 are trained, or generated using training data, in training phase 402. As is discussed in more detail below, one or more topical and general models can be trained during this phase. In accordance with one or more embodiments, the training phase 402 can be performed to generate a new model, or make medications and/or refinements to an existing model.

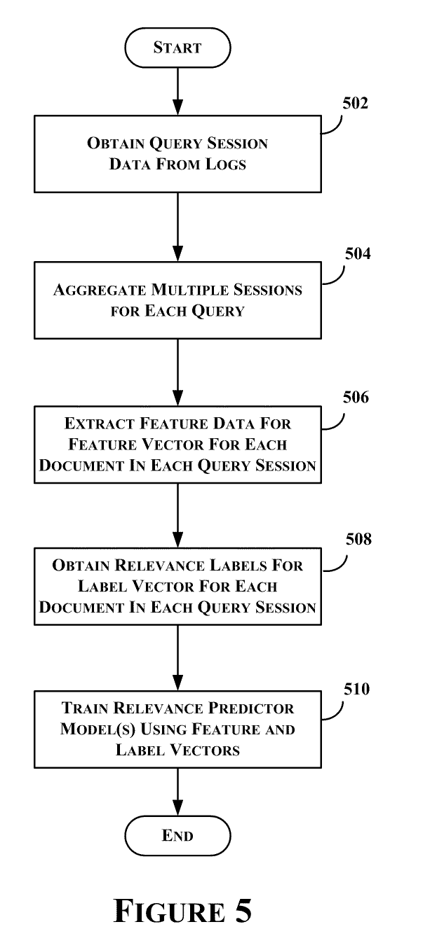

FIG. 5 provides a model generation process flow used in accordance with one or more embodiments of the present disclosure. In accordance with one or more such embodiments, the training phase 402 receives training data at step 502 of the training phase. By way of a non-limiting example, the training data comprises click log data from user click log(s) 106. By way of a further non-limiting example, the click log data obtained from user click log(s) 106 is preprocessed to extract a plurality of user click sessions, each of which comprises a query submitted to search engine 102, the documents included in the result set for the query, and click information indicating whether or not a document is clicked on by the user during the session, and time stamps for the user clicks.

In accordance with one or more embodiments, step 504 is an optional step, at which multiple sessions for the same query are aggregated, as discussed herein. At step 506, feature data is extracted using the training data obtained at step 502, and optionally at step 504. As discussed herein, in accordance with one or more embodiments, one or more features are used to represent relationships between documents determined using the presence and/or absences of document click sequences identified using the training data. It should be apparent that additional features, such as and without limitation features of the documents and/or query, can be used in combination with the document click sequence features to train a model in accordance with one or more embodiments.

In accordance with one or more embodiments, a supervised approach is used to train a model using relevance labels obtained at step 508; a relevance label is associated with a query-document pair and identifies a relevance of the document to the query. In accordance with one or more embodiments, the relevance labels are obtained from human judges that assess the relevance of the document to the query and assign a score based on the assessment. In accordance with one or more embodiments disclose herein, a relevance label for a document, or document pair, can be determined using click data. At step 510, one or more relevance predictor models 110 are generated using the feature and label vectors from steps 506 and 508.

Referring again to FIG. 4, in accordance with one or more embodiments, a query and corresponding result set of documents can be used with one or more models trained during the training phase 402 to generate predictions, or estimates, of the relevance rankings of the documents in the result set.

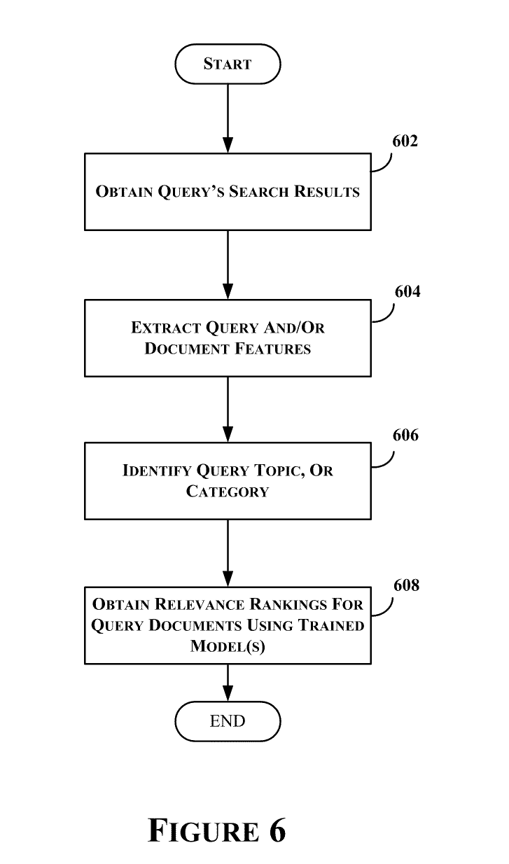

FIG. 6 provides a relevance prediction process flow used in accordance with one or more embodiments of the present disclosure. At step 602, a query is performed to obtain a set of search results. At step 604, features of the query and document are extracted. At step 606, which can be optionally performed, a topic, or category, is determined for the query, as is discussed in more detail below. At step 608, a relevance ranking for each of the documents in the set of search results is obtained using one or more relevance predictor models 110. In a case that step 606 is performed, step 606, or step 608, can select one or more topical relevance predictor models 110 corresponding to the query topic(s) identified in step 606; and step 608 can use the selected relevance predictor model(s) 110 with or without one or more general relevance predictor models 110 to generate the document relevance rankings.

Topical Ranking

In accordance with one or more embodiments, relevance predictor model(s) 110 comprises a general relevance predictor model and/or a plurality of topical relevance predictor models, each topical model corresponding to a topic, or a query category. By way of some non-limiting examples, query categories can include a category of navigation queries, a category of news queries, a category of product categories, etc. In accordance with one or more embodiments, an analyzer, e.g., a query linguistic analyzer, can be used to segment a query into one or more tags and identify a type, e.g., a semantic concept, meaning, etc. for each identified tag. In accordance with one or more such embodiments, topical training data generator of the training data generator 128 can comprise the linguistic analyzer. The output of query linguistic analyzer, e.g., tag and tag type, is used to determine whether a query document pair belongs to a topic or topic class. By way of some non-limiting examples, a tag having a product-related type, such as product brand, manufacturer name, model number, etc., can be considered to belong to a product topic class; and person-related tags, e.g., person name tag type can be considered to belong to a person class. More than one tag type can be used to identify a topic or topic class. By way of another non-limiting example, a query that contains tags of type business name and a location-related tag type, such as street name, city name, state name, etc., can be considered to belong to a local query topic class.

In accordance with one or more embodiments, relevance predictor model generator 108 uses the output of the query linguistic analyzer to identify queries to obtain training data to train a topical relevance predictor model 110, which is then used by relevance predictor module 112 to rank documents in a set of search results retrieved using a query determined to fall in the topic or category for which the topical relevance predictor model 110 was generated. In accordance with one or more embodiments, the query linguistic analyzer can be used by relevance predictor module 112 to identify a category or topic for a query, and then select a topical relevance predictor model 110 corresponding to the identified category or topic of the query. In accordance with one or more embodiments, the relevance predictor module 112 can use the selected topical relevance predictor model 110 alone or in combination with a generic relevance predictor model 110, both of which can be generated by the relevance predictor model generator 108 in accordance with one or more embodiments of the present disclosure.

In accordance with one or more embodiments, a topical ranking uses a dedicated model for the queries belonging to the category (topic). Such a dedicated model can be trained based on the labeled data belonging to this topic, which is referred to herein as dedicated training data. However, the amount of dedicated training data for one topic is usually insufficient, primarily due to the cost and time involved in obtaining the relevance labeling from human judges for training data needed to generate a topical relevance predictor model 110 for the topic.

In accordance with one or more embodiments, clickthrough data is extracted and incorporated with dedicated training data to generate a topical relevance predictor model 110 for a topic. By way of a non-limiting example, the clickthrough data is extracted by a topical training data generator of training data generator 128. Advantageously, the clickthrough data is used to address insufficiencies, absence or paucity, of human judgment relevance labels for training data used in topical ranking In accordance with one or more embodiments, clickthrough data is used to generate a relevance predictor model 110 for a given query topic, or category. In accordance with one or more such embodiments, pair-wise preference data is generated and is input to relevance predictor model generator 108, which uses a GBrank method, to train a topical relevance predictor model 110 for a given topic, or query, category.

Embodiments of the present disclosure can use various methods, or strategies, to extract relative relevance, or pair-wise, judgments from clickthrough data. Advantageously, use of such methods, or strategies, can minimize biases and other potential errors in interpreting individual click behavior, click information from different query sessions is aggregated before applying heuristic rules. In accordance with one or more embodiments, heuristic rules are used to extract skip-above pairs and skip-next pairs, using skip above, which is also referred to as click>skip above, and the skip next, which is also referred to as click>no-click next, strategies. The skip above strategy proposes that given a clicked-on document, any document in a higher position in the result set displayed to the user that was not clicked on can be considered to be less relevant. The skip next strategy proposes that for two adjacent documents in the search result set, if the first document, i.e., the document immediate above the second document in the result set displayed to the user, is clicked on, but the second is not, the first document can be considered to be more relevant than the second document. In accordance with one or more embodiments, the skip above strategy can be used to identify pair-wise preferences, or judgments, between two documents in an order that is the reverse of the order used to position the documents in the result set, and the skip next strategy can be used to confirm the result set order. Alternatively, the skip above strategy can indicate that the result set order is appropriate, and/or that pair-wise preferences, or judgments, between documents indicated by the result set order are appropriate, if the conditions associated with the skip above strategy are not found in the user click data; and the skip next strategy can indicate that the result set order is not accurate in a case that the conditions associated with the skip next strategy are not found in the user click data.

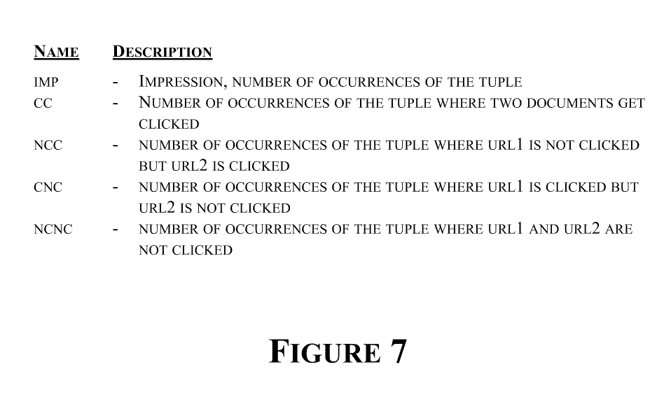

In accordance with one or more embodiments, for a tuple (q; url₁; url₂; pos₁; pos₂) where q represents a query, url₁ and url₂ are universal resource locators that represent two documents, pos₁ and pos₂ represent the respective ranking positions of the two documents in a one or more sets of search results, with pos₁>pos₂, to indicate that url₁ has higher rank than url₂. In accordance with one or more embodiments, metrics, such as and without limitation, those shown in FIG. 7 are used to extract the pair-wise judgments.

In accordance with one or more embodiments, a skip-above pair-wise judgment is found between url₁ and url₂: if ncc is much larger than cnc, in accordance with a first threshold, and

$$\frac{cc}{imp} and \frac{ncnc}{imp}$$

are both much smaller than 1, in accordance with a second threshold. If these conditions exist and url₁ is ranked higher than url₂ in query q, most users clicked on url₂ but did not click url₁. In this case, a skip-above pairing is identified for url₁ and url₂, i.e., url₂ is more relevant than url₁. In accordance with one or more embodiments, in order to have highly accurate skip-above pairs, a set of thresholds are applied to only extract the pairs that have a high impression and ncc exceeds cnc by a large enough margin. In accordance with one or more such embodiments, the first threshold is used in connection with the “much larger” determination between ncc and cnc; such that a difference between ncc and cnc satisfies the first threshold indicating an acceptable degree, or margin, of difference between ncc and cnc. Furthermore and in accordance with one or more such embodiments, the second threshold is used in connection with the “much smaller” determination, such that the differences between

$$\frac{cc}{imp}$$

and 1, and

$$\frac{ncnc}{imp}$$

and 1 satisfy a second threshold indicating an acceptable degree, or margin, of difference. In accordance with one or more embodiments, the second threshold can be a single threshold, or two separate thresholds, each of which corresponds to one of the “much smaller” determinations.

In accordance with one or more embodiments, a skip-next pair-wise judgment is found: if pos₁=pos₂−1, indicating that url₁ is positioned immediately above url₂ in the search results, cnc is much larger than ncc, in accordance with a first threshold, and

$$\frac{cc}{imp} and \frac{ncnc}{imp}$$

are both much smaller than 1, in accordance with a second threshold. If these conditions exist and url₂ is ranked, or positioned, immediately below url₁ in query q, most users click url₁ but do not click url₂. In this case, this tuple is regarded as a skip-next pairing. In accordance with one or more such embodiments, the first threshold is used in connection with the “much larger” determination between cnc and ncc; such that a difference between cnc and ncc satisfies the first threshold indicating an acceptable degree, or margin, of difference between cnc and ncc. Furthermore and in accordance with one or more such embodiments, the second threshold is used in connection with the “much smaller” determination, such that the differences between

$$\frac{cc}{imp}$$

and 1, and

$$\frac{ncnc}{imp}$$

and 1 satisfy a second threshold indicating an acceptable degree, or margin, of difference. In accordance with one or more embodiments, the second threshold can be a single threshold, or two separate thresholds, each of which corresponds to one of the “much smaller” determinations.

In accordance with one or more embodiments, other pair-wise strategies can be used to identify pair-wise relevance judgments, and preferences, using clickthrough data. In accordance with one or more embodiments, with the GBrank method: for each pair-wise preference, if a pair-wise ordering of a current ranking function contradicts the pair-wise preference, the current ranking function, h, is modified to optimize its agreement with the pair-wise preference, as closely as possible without impacting its overall agreement with the preferences as a whole, i.e., to minimize the error or differences between the estimated ranking(s) generated by the ranking function, h, and the ranking(s) suggested by the preference data.

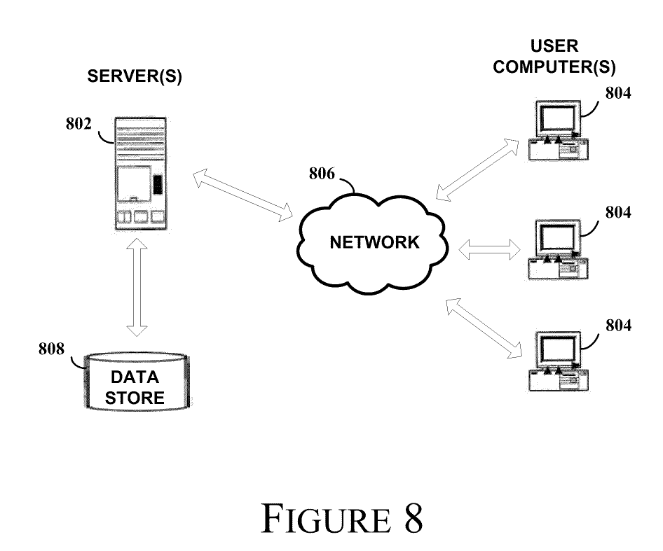

FIG. 8 illustrates some components that can be used in connection with one or more embodiments of the present disclosure. In accordance with one or more embodiments of the present disclosure, one or more computing devices, e.g., one or more servers, user devices 114 or other computing device, 802 are configured to comprise functionality described herein. For example, a computing device 802 can be configured as relevance predictor model generator 108, which uses training data in a machine learning phase, to generate one or more relevance predictor models 110 in accordance with one or more embodiments of the present disclosure. The same or another computing device 802 can be configured as search engine 102, which can comprise one more of a crawler, searching and ranker of search result items, or documents, and associated resources, relevance predictor 112, which supplies a relevance, or ranking, prediction for a given document based on the features extracted for the document and one or more relevance prediction models 110 in accordance with one or more embodiments. The same or another computing device 802 can be associated with one or more resource data stores 104. It should be apparent that one or more of the search engine 102, relevance predictor model generator 108, training data generator 128, human judgment interface 118 and relevance predictor 112 can be provided using the same, or different, computing device 802. In accordance with one or more embodiments, when executing computer code accessible to one or more processors, or processing units, 912, computing device 802 comprises a special purpose computing device providing one or more of search engine 102, relevance predictor model generator 108, training data generator 128, human judgment interface 118 and relevance predictor 112. In accordance with one or more embodiments, the computer code is accessible to one or more processing units 912 via a storage medium tangibly storing the computer code.

Data store 808, which can include data store 104, can be used to store training and/or evaluation data sets, click logs, resources associated with URLs, relevance predictor models, absolute and/or relative judgments and/or preference data; and/or program code to configure a server 802 to execute the search engine 102, relevance predictor model generator 108 and/or relevance predictor 112, training data generator 128, human judgment interface 118, configuration information, etc.

The user computer 804, and/or user device 114, can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 802 and the user computer 804 can include one or more processors, memory, a removable media reader, network interface, display and interface, and one or more input devices, e.g., keyboard, keypad, mouse, etc. and input device interface, for example. One skilled in the art will recognize that server 802 and user computer 804 may be configured in many different ways and implemented using many different combinations of hardware, software, or firmware.

In accordance with one or more embodiments, a computing device 802 can make a user interface available to a user computer 804 via the network 806. The user interface made available to the user computer 804 can include content items, or identifiers (e.g., URLs) selected for the user interface based on relevance, or ranking, prediction(s) generated in accordance with one or more embodiments of the present invention. In accordance with one or more embodiments, computing device 802 makes a user interface available to a user computer 804 by communicating a definition of the user interface to the user computer 804 via the network 806. The user interface definition can be specified using any of a number of languages, including without limitation a markup language such as Hypertext Markup Language, scripts, applets and the like. The user interface definition can be processed by an application executing on the user computer 804, such as a browser application, to output the user interface on a display coupled, e.g., a display directly or indirectly connected, to the user computer 804.

In accordance with one or more embodiments, computing device 802 can serve content to a user computer 804 executing a browser application via a network 806. In accordance with one or more embodiments, computing device 802 can serve search results to a user computer 804 in response to receiving a query received from user computer 804, and receive click data in the form of URL selections, for example. In accordance with one or more embodiments, human judge interface 118 can comprise one or more web pages identifying a query and documents in a result set generated using the query, and at least one computing device 802 configured to transmit the one or more web pages for display at the user computer 804 for the judge, and to receive the judge's input, which includes the judge's assessment of a document's relevance to a query.

In an embodiment the network 806 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 8. Alternatively, embodiments of the present disclosure can be implemented other environments, e.g., a peer-to-peer environment as one non-limiting example.

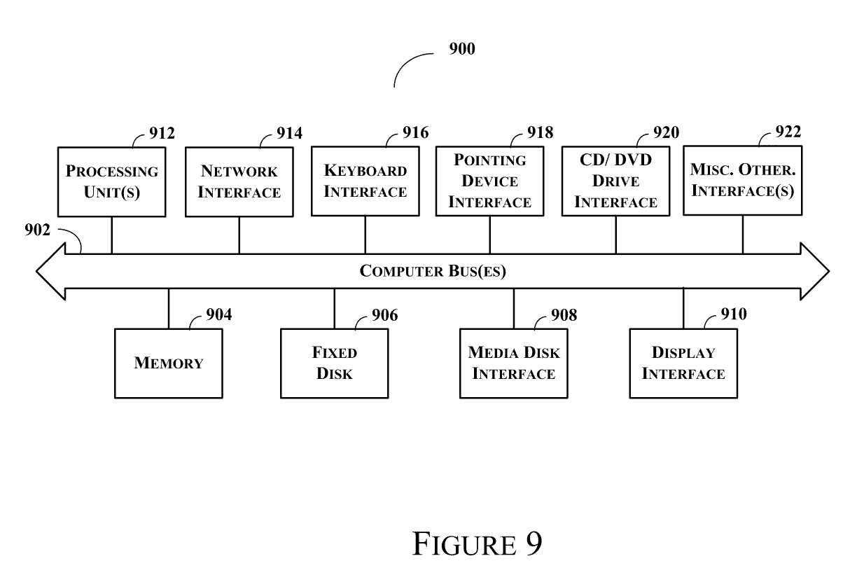

FIG. 9 is a detailed block diagram illustrating an internal architecture of a computing device, such as server 802 and/or user computing device 804, in accordance with one or more embodiments of the present disclosure. As shown in FIG. 9, internal architecture 900 includes one or more processing units (also referred to herein as CPUs) 912, which interface with at least one computer bus 902. Also interfacing with computer bus 902 are fixed disk 906, network interface 914, memory 904, e.g., random access memory (RAM), run-time transient memory, read only memory (ROM), etc., media disk drive interface 908 as an interface for a drive that can read and/or write to media including removable media such as floppy, CD-ROM, DVD, etc. media, display interface 910 as interface for a monitor or other display device, keyboard interface 916 as interface for a keyboard, pointing device interface 918 as an interface for a mouse or other pointing device, and miscellaneous other interfaces not shown individually, such as parallel and serial port interfaces, a universal serial bus (USB) interface, and the like.

Memory 904 interfaces with computer bus 902 so as to provide information stored in memory 904 to CPU 912 during execution of software programs such as an operating system, application programs, device drivers, and software modules that comprise program code, and/or computer-executable process steps, incorporating functionality described herein, e.g., one or more of process flows described herein. CPU 912 first loads computer-executable process steps from storage, e.g., memory 904, fixed disk 906, removable media drive, and/or other storage device. CPU 912 can then execute the stored process steps in order to execute the loaded computer-executable process steps. Stored data, e.g., data stored by a storage device, can be accessed by CPU 912 during the execution of computer-executable process steps.

Persistent storage, e.g., fixed disk 906, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code executable by a computer, in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
training, by at least one processor, a relevance prediction model using data for a plurality of queries, the data for a query comprising information identifying the query and documents of a result set retrieved using the query, the data further comprising user click information identifying each user click and corresponding document in the result set and a time of the user click, the training comprising:
determining a plurality of feature vector sets corresponding to the plurality of queries, a feature vector set for a query comprising a feature vector for each document in the result set of the query, the feature vector identifying a plurality of features and a corresponding plurality of feature values, the plurality of features for a document comprising at least one feature that relates the document to at least one other document in the result set of the query using the user click information to determine whether or not a user click sequence involving the document and the at least one other document exists;
determining a plurality of label sets corresponding to the plurality of queries, a label set for a query comprising a label for each document in the result set of the query, the label comprising an assessment of the document's relevance to the query;
generating the relevance prediction model using the feature vector and label sets; and
obtaining, by the at least one processor and using the generated relevance prediction model, ranking predictions for documents in a result set of a query.

2. The method of claim 1, the label for a document comprising a human judge's assessment of the document's relevance to the query.

3. The method of claim 1, the label for a document clicked on in the result set and positioned below another document not clicked on in the result set is based on a relative relevance determined in accordance with a skip above strategy, the relative relevance indicating that the clicked-on document positioned below the other document not clicked on is more relevant than the other document.

4. The method of claim 1, the label for a document clicked on in the result set and positioned immediately above another document not clicked on in the result set is based on a relative relevance determined in accordance with a skip next strategy, the relative relevance indicating that the clicked-on document positioned immediately above the other document not clicked on is more relevant than the other document.

5. The method of claim 1, the data for a query comprising data from a plurality of query sessions, each query session involving the query and having a result set of document and user click information, training a relevance prediction model further comprising:
aggregating the data from the plurality of query sessions for the query; and
using the aggregated data to determine the feature vector and label sets for the query.

6. The method of claim 1, the at least one other document is positioned immediately below the document in the result set, and the feature that relates the document to the at least one other document identifying whether user clicks exist in the click information for the document and the at least one other document in the click information.

7. The method of claim 1, the at least one other document is positioned immediately above the document in the result set, and the feature that relates the document to the at least one other document identifying whether user clicks exist in the click information for the document and the at least one other document in the click information.

8. The method of claim 1, the at least one other document is positioned below the document in the result set, and the feature that relates the document to the at least one other document identifying whether user clicks exist in the click information for the document and the at least one other document in the click information.

9. The method of claim 1, the at least one other document is positioned above the document in the result set, and the feature that relates the document to the at least one other document identifying whether user clicks exist in the click information for the document and the at least one other document in the click information.

10. The method of claim 1, generating the relevance prediction model using the feature vector and label sets further comprising:
generating the relevance prediction model using the feature vector and label sets using a global ranking training method.

11. The method of claim 10, the global ranking training method comprises a conditional random fields training method.

12. The method of claim 10, the global ranking training method comprises a sliding window training method.

13. The method of claim 10, the global ranking training method comprises a recurrent window training method.

14. The method of claim 10, the global ranking training method comprises a GBrank training method.

15. The method of claim 1, the relevance prediction model comprises a plurality of topical relevance prediction models, each topical relevance prediction model corresponding to a category of queries.

16. The method of claim 15, obtaining ranking predictions for documents in a result set of a query further comprising:
identifying, by the at least one processor, a category for the query;
selecting, by the at least one processor, a topical relevance prediction model from the plurality based on the category identified for the query; and
obtaining, by the at least one processor and using the selected topical relevance prediction model, ranking predictions for the documents in the result set of the query.

17. A system comprising:
at least one server, the at least one server comprising:
a training data generator that uses data for a plurality of queries to determine a plurality of feature vector sets and a plurality of label sets corresponding to the plurality of queries, the data for a query comprising information identifying the query and documents of a result set retrieved using the query, the data further comprising user click information identifying each user click and corresponding document in the result set and a time of the user click, a feature vector set for a query comprising a feature vector for each document in the result set of the query, the feature vector identifying a plurality of features and a corresponding plurality of feature values, the plurality of features for a document comprising at least one feature that relates the document to at least one other document in the result set of the query using the user click information to determine whether or not a user click sequence involving the document and the at least one other document exists, and a label set for a query comprising a label for each document in the result set of the query, the label comprising an assessment of the document's relevance to the query;
a relevance predictor model generator that generates a relevance prediction model using the plurality of feature vector and label sets;
a relevance predictor that obtains, using the generated relevance prediction model, ranking predictions for documents in a result set of a query.

18. The system of claim 17, the label for a document comprising a human judge's assessment of the document's relevance to the query.

19. The system of claim 17, the label for a document clicked on in the result set and positioned below another document not clicked on in the result set is based on a relative relevance determined in accordance with a skip above strategy, the relative relevance indicating that the clicked-on document positioned below the other document not clicked on is more relevant than the other document.

20. The system of claim 17, the label for a document clicked on in the result set and positioned immediately above another document not clicked on in the result set is based on a relative relevance determined in accordance with a skip next strategy, the relative relevance indicating that the clicked-on document positioned immediately above the other document not clicked on is more relevant than the other document.

21. The system of claim 17, the data for a query comprising data from a plurality of query sessions, each query session involving the query and having a result set of document and user click information, the training data generator:
aggregates the data from the plurality of query sessions for the query; and
uses the aggregated data to determine the feature vector and label sets for the query.

22. The system of claim 17, the at least one other document is positioned immediately below the document in the result set, and the feature that relates the document to the at least one other document identifying whether user clicks exist in the click information for the document and the at least one other document in the click information.

23. The system of claim 17, the at least one other document is positioned immediately above the document in the result set, and the feature that relates the document to the at least one other document identifying whether user clicks exist in the click information for the document and the at least one other document in the click information.

24. The system of claim 17, the at least one other document is positioned below the document in the result set, and the feature that relates the document to the at least one other document identifying whether user clicks exist in the click information for the document and the at least one other document in the click information.

25. The system of claim 17, the at least one other document is positioned above the document in the result set, and the feature that relates the document to the at least one other document identifying whether user clicks exist in the click information for the document and the at least one other document in the click information.

26. The system of claim 17, wherein the relevance predictor model generator generates the relevance prediction model using the feature vector and label sets using a global ranking training method.

27. The system of claim 26, the global ranking training method comprises a conditional random fields training method.

28. The system of claim 26, the global ranking training method comprises a sliding window training method.

29. The system of claim 26, the global ranking training method comprises a recurrent window training method.

30. The system of claim 26, the global ranking training method comprises a GBrank training method.

31. The system of claim 17, the relevance prediction model comprises a plurality of topical relevance prediction models, each topical relevance prediction model corresponding to a category of queries.

32. The system of claim 31, the relevance predictor:
identifies a category for the query;
selects a topical relevance prediction model from the plurality based on the category identified for the query; and
obtains, using the selected topical relevance prediction model, ranking predictions for the documents in the result set of the query.

33. A computer-readable medium tangibly storing thereon computer-executable process steps, the process steps comprising:
training a relevance prediction model using data for a plurality of queries, the data for a query comprising information identifying the query and documents of a result set retrieved using the query, the data further comprising user click information identifying each user click and corresponding document in the result set and a time of the user click, the training comprising:
determining a plurality of feature vector sets corresponding to the plurality of queries, a feature vector set for a query comprising a feature vector for each document in the result set of the query, the feature vector identifying a plurality of features and a corresponding plurality of feature values, the plurality of features for a document comprising at least one feature that relates the document to at least one other document in the result set of the query using the user click information to determine whether or not a user click sequence involving the document and the at least one other document exists;
determining a plurality of label sets corresponding to the plurality of queries, a label set for a query comprising a label for each document in the result set of the query, the label comprising an assessment of the document's relevance to the query;
generating the relevance prediction model using the feature vector and label sets; and
obtaining, using the generated relevance prediction model, ranking predictions for documents in a result set of a query.

34. The medium of claim 33, the label for a document comprising a human judge's assessment of the document's relevance to the query.

35. The medium of claim 33, the label for a document clicked on in the result set and positioned below another document not clicked on in the result set is based on a relative relevance determined in accordance with a skip above strategy, the relative relevance indicating that the clicked-on document positioned below the other document not clicked on is more relevant than the other document.

36. The medium of claim 33, the label for a document clicked on in the result set and positioned immediately above another document not clicked on in the result set is based on a relative relevance determined in accordance with a skip next strategy, the relative relevance indicating that the clicked-on document positioned immediately above the other document not clicked on is more relevant than the other document.

37. The medium of claim 33, the data for a query comprising data from a plurality of query sessions, each query session involving the query and having a result set of document and user click information, the process step of training a relevance prediction model further comprising:
aggregating the data from the plurality of query sessions for the query; and
using the aggregated data to determine the feature vector and label sets for the query.

38. The medium of claim 33, the at least one other document is positioned immediately below the document in the result set, and the feature that relates the document to the at least one other document identifying whether user clicks exist in the click information for the document and the at least one other document in the click information.

39. The medium of claim 33, the at least one other document is positioned immediately above the document in the result set, and the feature that relates the document to the at least one other document identifying whether user clicks exist in the click information for the document and the at least one other document in the click information.

40. The medium of claim 33, the at least one other document is positioned below the document in the result set, and the feature that relates the document to the at least one other document identifying whether user clicks exist in the click information for the document and the at least one other document in the click information.

41. The medium of claim 33, the at least one other document is positioned above the document in the result set, and the feature that relates the document to the at least one other document identifying whether user clicks exist in the click information for the document and the at least one other document in the click information.

42. The medium of claim 33, the process step of generating the relevance prediction model using the feature vector and label sets further comprising:
generating the relevance prediction model using the feature vector and label sets using a global ranking training method.

43. The medium of claim 42, the global ranking training method comprises a conditional random fields training method.

44. The medium of claim 42, the global ranking training method comprises a sliding window training method.

45. The medium of claim 42, the global ranking training method comprises a recurrent window training method.

46. The medium of claim 42, the global ranking training method comprises a GBrank training method.

47. The medium of claim 33, the relevance prediction model comprises a plurality of topical relevance prediction models, each topical relevance prediction model corresponding to a category of queries.

48. The medium of claim 47, the process step of obtaining ranking predictions for documents in a result set of a query further comprising:
identifying a category for the query;
selecting a topical relevance prediction model from the plurality based on the category identified for the query; and
obtaining, using the selected topical relevance prediction model, ranking predictions for the documents in the result set of the query.
